(19) United States
(12) Patent Application Publication
(10) Pub. No.: US 2015/0374007 A1
(43) Pub. Date: Dec. 31, 2015

(54) ANAEROBIC FERMENTATION OF SEEDS OF FRUIT

(71) Applicant: MARS, INCORPORATED, Mclean, VA (US)

(72) Inventors: Raymond John Schnell, II, Miami, FL (US); Edward Stephen Seguine, Hanover, PA (US); Cristiano Villela Dias, Itabuna (BR); Carolina Schaper Bizzotto, Itabuna (BR); Jean-Philippe Marelli, Ilheus (BR); David Andrew Mills, Davis, CA (US); Juan Carlos Motamayor-Arias, Miami, FL (US)

(73) Assignee: MARS, INCORPORATED, McLean, VA (US)

(21) Appl. No.: 14/767,189

(22) PCT Filed: Feb. 13, 2014
(86) PCT No.: PCT/US2014/016264

§ 371 Date: Aug. 11, 2015

Related U.S. Application Data
(60) Provisional application No. 61/765,351, filed on Feb. 15, 2013.
(60) Provisional application No. 61/783,300, filed on Mar. 14, 2013.

(51) Int. Cl. A23G 1/02; A23G 1/30

(52) U.S. Cl. CPC A23G 1/02; A23G 1/30; A23V 2002/00

(57) ABSTRACT

The present invention provides methods for processing seeds of fruit, such as cocoa beans.

### RELATED APPLICATIONS

This application claims the benefit of U.S. Application No. 61/765,351, filed Feb. 15, 2013, and U.S. Application No. 61/783,300, filed Mar. 14, 2013, the contents of which are herein incorporated by reference in their entireties.

### FIELD OF THE INVENTION

The present invention relates generally to methods for processing seeds of fruit including but not limited to cocoa beans, cupuacu beans and/or coffee beans suitable for making products such as cocoa, cupuacu and/or coffee products under substantially anaerobic conditions.

### BACKGROUND OF THE INVENTION

Cocoa beans are the principal raw material for chocolate production. These beans are derived from the fruit pods of the tree Theobroma cacao L., which is cultivated in farms in the equatorial zone, e.g., in Brazil, Costa Rica, Ecuador, Indonesia, Ivory Coast, Ghana and Vietnam. The cocoa beans are surrounded by a mucilaginous pulp inside the pods. Raw cocoa beans have an astringent, unpleasant taste and flavor. Traditionally to obtain the characteristic cocoa flavor and taste, cocoa beans have undergone microbial fermentation by both yeast and bacteria, dried, and roasted.

Chocolate flavor is influenced by the origin of the cocoa beans, the cocoa cultivars or genotypes, the on-the-farm fermentation and drying process, and the roasting and further processing performed by the chocolate manufacturer.

Some suggest that the flavor quality of the fermented cocoa beans is predominantly due to transport kinetics of water and solutes during the fermentation but the full details of this flavor development are poorly understood. Cocoa fermentation process is very heterogeneous and suffers from great variations in both microbial counts and species composition and hence metabolites. The variations seem to depend on many factors including country, farm, pod ripeness, post-harvest pod age and storage, pod diseases, type of cocoa, variations in pulp/bean ratio, the fermentation method, size of the batch, the location of the bean within the batch, season and weather conditions, the turning frequency or no turning, the fermentation time, etc. which makes reproducibility of fermentation particularly difficult. Because the uncontrolled nature of the usual fermentation process, particularly with respect to the lack of control over the growth and development of microorganisms and metabolic production during the process, the quality of the finished cocoa beans and the resultant cocoa products is variable.

A need exists for a method of processing cocoa beans that allows for the characteristic cocoa flavor and taste to develop without the variations inherent in microbial fermentation. Accordingly, the invention provides a controlled method of processing raw cocoa beans without aerobic (e.g., bacterial) fermentation that produces cocoa products having the desired cocoa flavor.

### SUMMARY OF THE INVENTION

The invention provides methods of fermenting seeds of fruit, e.g., cocoa beans, cupuacu beans or coffee beans by placing a bulk quantity of the seeds in an airtight container; sealing the container; and fermenting the seeds at a controlled temperature for a predetermined period of time under anaerobic conditions. Optionally, the container comprises an airlock.

The controlled temperature is between 28-50° C. and preferably between 30-50° C. In some embodiments the controlled temperature is at least 28° C., at least 30° C. or at least 37° C.

The predetermined period of time is less than two weeks. Preferably, the predetermined period of time is between 24 to 168 hours.

In some embodiments after about 72 hours the temperature is maintained at about 44° C. for at least an additional 48 hours. In other embodiments the controlled temperature is increased at defined intervals until a desired maximal temperature is reached. For example the controlled temperature is increased until a temperature of about 44° C. or 48° C. is obtained. Optionally, after the temperature of 44° C. or 48° C. is obtained the temperature is maintained at 44° C. or 48° C. for at least an additional 48 hours.

In a specific embodiment the controlled temperature is held at least 37° C. for the predetermined period of time of no more that about 144 hours. In another embodiment the controlled temperature is at least 30° C. and the predetermined period of time is for at least 126 hours. In another embodiment the controlled temperature is above 28° C. for the majority of the predetermined period of time. In a preferred embodiment, the controlled temperature follows the temperature profile as illustrated in FIG. 1.

Preferably, acetic acid is not produced at significantly increased levels compared to starting unfermented seeds.

In some embodiments the methods further includes inoculating the seeds with a starter culture prior to sealing the container. Optionally, the seeds are treated with a microbial growth inhibitor prior to inoculating with the starter culture

The starter culture contains yeast. The starter culture does not contain acetic acid bacteria and lactic acid bacteria.

In some aspects, the method further includes displacing the air or portion thereof prior to sealing the container. For example, the air is displaced with a non-oxidizing gas such as carbon dioxide, argon, or nitrogen.

In other aspects the method further includes separating the sweatings from the seeds at one or more a times during the fermentation

In yet other aspects, the methods further include mechanically or physically processing the seeds. Mechanical processing includes for example, chopping, bruising or piercing the testa. Physical processing includes for example, a thermal treatment (e.g., heating, chilling or freezing), a microwave treatment, a treatment under water-saturated conditions, an ultrasound treatment, an infra-red treatment, a laser treatment, a pressure treatment, or a vacuum treatment

In some embodiments the methods of the invention further include drying the processed seeds until the total moisture content is about 5 to 10 percent to produce dried seeds. Optionally, the dried seeds are roasted. In further embodiments, the shell is removed from the roasted seeds and the cocoa nibs are recovered. The cocoa nibs are then milled to produce cocoa liquor.

The invention further includes the cocoa beans, cupuacu beans or coffee beans produced according to the methods of the invention and there used in the manufacture of cupuacu products, coffee products and cocoa products. The invention further provides the food products produced with the cupuacu, coffee and cocoa products of the invention.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, the materials, methods, and examples described herein are illustrative only and are not intended to be limiting. Other features and advantages of the invention will be apparent from and encompassed by the following detailed description and claims.

### BRIEF DESCRIPTION OF THE DRAWINGS

FIG. 1 shows a temperature profile during anaerobic fermentation according to the method of the invention.

FIG. 2 is a spider graph representation of the results of table 2.

### DETAILED DESCRIPTION OF THE INVENTION

The invention is based on the discovery that aerobic fermentation of cocoa beans and/or their pulp is not required to obtain the desired characteristic of cocoa flavor and taste. This is surprising since it is generally accepted that both anaerobic and aerobic fermentation is important in the flavor development of cocoa beans. Further, it has been found that carrying out anaerobic fermentation under conditions of at least 28° C., preferably at least 30° C. for a predetermined period of time of less than two weeks, even less than one week, results in cocoa beans that have fewer off-flavors compared to cocoa beans fermented at lower temperatures in otherwise similar conditions. Before cocoa can be processed into final products (i.e., cocoa liquor, cocoa powder, or cocoa butter) they must undergo post-harvest processing comprising the steps of pod opening, bean removal from the pod, fermentation and drying. In this process, it is well accepted in the art that fermentation constitutes an essential critical step for the development of cocoa flavor.

Typically, the microbial activity in cocoa bean pulp is considered as a defined microbial succession during a traditional fermentation led by yeasts that will dominate the total microbiome during the first hours after which their level is surpassed by lactic acid bacteria which in turn will decline after 48 hours of fermentation in favor of the vigorous development of obligately-aerobic acetic acid bacteria.

Various attempts have been made in the prior art to control the processing of cocoa beans.

For example W0 2007/031186 discloses a method of regulating the fermentation of plant material by adding specific bacterial cultures containing lactic acid bacterium and acetic acid bacterium at different times during the fermentation process.

W0 2008/137577 discloses alcoholic fermentation of cocoa beans for at least 14 days at temperatures from 24° C. to 28° C.

U.S. Pat. No. 5,342,632 discloses a method for treating cocoa beans for improving fermentation by removing and separating a portion of the pulp from the fresh cocoa beans and fermenting the partly depulped cocoa beans under highly aerobic conditions.

GB 305236 discloses a process and apparatus for fermenting cocoa beans by placing the beans in a receptacle with ventilating devices to avoid over-heating.

In contrast, the present inventors have shown that beans subjected to a substantially anaerobic fermentation at a temperature of at least 28° C. (preferably between 44° C. to 48° C.) for a period less than 1 week produces cocoa with acceptable taste and quality.

Accordingly, the invention provides a method of processing cocoa beans for the production of cocoa products without the need for aerobic (e.g. acetic acid bacterial) fermentation. The invention provides a method of processing cocoa beans into cocoa products having a desired flavor and organoleptic properties. The invention provides high-flavored cocoa beans by means of a simple, faster, more controllable (i.e., less variable) and reproducible process, resulting in a cocoa product having a controllable, well-defined and repeatable flavor and taste profile.

One skilled in the art would readily recognize that the methods disclosed herein may be used to process other seeds of fruit that require fermentation such as cupuacu bean, coffee beans or tomato seeds.

In the present invention, the tree material is preferably derived from any species of the genera Theobroma or Herrania or inter- and intra-species crosses thereof within those genera, and more preferably from the species Theobroma cacao and Theobroma grandiflorum. The species Theobroma cacao as used herein comprises all genotypes, particularly all commercially useful genotypes, including but not limited to Criollo, Forastero, Trinitario, Arriba, Amelonado, Contamana, Curaray, Guiana, Iquitos, Maranon, Nacional, Nanay and Purus, and crosses and hybrids thereof. Cocoa beans derived from the fruit pods of Theobroma cacao are the principal raw material for chocolate production. The cocoa beans are surrounded by a mucilaginous pulp inside the pods. After the pods are harvested, the cocoa beans (usually including at least a portion of the surrounding pulp) are recovered from the pods. Accordingly, the tree material used in the method of the invention may preferably comprise cocoa beans derived from the fruit pods of Theobroma cacao, and may further comprise the pulp derived from the fruit pods. In an embodiment, the tree material may consist essentially of cocoa beans and the pulp derived from the fruit pods of Theobroma cacao.

The terms “cocoa” and “cacao” as used herein are considered as synonyms.

The term “fermentation” refers generally to any activity or process involving enzymatic or metabolic decomposition (digestion) of organic materials by microorganisms. The term “fermentation” encompasses both anaerobic and aerobic processes, as well as processes involving a combination or succession of one or more anaerobic and/or aerobic stages. “Anaerobic” fermentation is meant that the conditions are such the decomposition of organic matter by microorganisms that prefer anaerobic conditions are favored over the decomposition of organic matter by microorganisms that prefer aerobic conditions. Likewise, “aerobic” fermentation is meant that the conditions are such the decomposition of organic matter by microorganisms that prefer aerobic conditions are favored over the decomposition of organic matter by microorganisms that prefer anaerobic conditions.

The term “fruit seed” or “seed of fruit” as used herein is intended to refer to the propagative part of a plant. A fruit seed can be, for example, a cocoa bean, a cupuacu bean or a coffee bean.

The term “coffee bean” collectively refers to the seeds (coffee seeds) that are obtained by the process (refining process) of removing the pulp and the skin from the berries (known as coffee berries or coffee cherries) of Coffea plants of the family Rubiaceae and the beans that are produced from these. Of these, “green” coffee beans are coffee beans that have not yet passed through a roasting process, which is a process in which the coffee beans are roasted by heating, and “roasted” coffee beans are coffee beans that have been roasted.

The term “cocoa beans” as used herein is intended to refer to cocoa beans or cocoa seeds as such as well as parts thereof. Cocoa beans basically consist of three parts: an outer part comprising the testa or seed coat surrounding the bean; an inner part comprising the cotyledons and the embryo or germ contained within the testa; and the pulp. The bean when broken is referred to as “cocoa nibs”. In the present specification, the terms “testa” or “shell” or “seed coat” are used as synonyms.

The term “pulp” in accordance with the present invention relates to the mucilaginous plant material in which cocoa beans are embedded inside the cocoa pods.

The term “cupuacu bean” as used herein is intended to refer to cupuacu beans or cupuacu seeds as such as well as parts thereof.

By “bulk quantity” it is meant greater than 600 grams of cocoa beans. Preferably, a bulk quantity is at least 1 kg, 2 kg, 5 kg or more.

The term “fermented cocoa beans” is intended to refer to cocoa beans that have been fermented either deliberately or adventitiously for at least one day, preferably at least two days, thus, that have undergone a fermentation process.

The term “unfermented cocoa beans” is intended to refer to cocoa beans that have been liberated from cocoa pods and have not yet been fermented. Unfermented cocoa beans generally are not yet germinated.

As used herein the term “non-depulped” cocoa beans refer to cocoa beans that have not been liberated from their pulp. The term “depulped” cocoa beans refers to cocoa beans that have been essentially liberated from their pulp. “Essentially liberated” refers to the removal from the cocoa beans of more than 40%, preferably more than 50, 65, 70, 75, 80, 85, 90, 95, 97, or 99% by weight of pulp based upon the original total combined weight of beans and pulp. The process according to the invention can use non-depulped cocoa beans, depulped cocoa beans or partially depulped cocoa beans.

The term “sweating” as used herein refers to the liquid material produced by microbial action on the fruit pulp.

The term “regulate” or “control” as used herein in relation to the fermentation of organic material encompasses, but is not limited to, initiating a fermentation process and/or initiating a particular stage of the fermentation process; accelerating or decelerating a fermentation process and/or accelerating or decelerating a particular stage of the fermentation process; initiating and/or accelerating or decelerating the transition from one stage of a fermentation process to another stage of the fermentation process; altering the conditions of the fermentation, such as, e.g., temperature or pH; altering the composition of the fermented material (e.g., altering the decomposition or production of particular substances present in the fermented material); altering the identity and/or quantity of microbial strains present in and/or carrying out the fermentation process; enhancing or suppressing the growth of particular microorganisms etc.

A “spontaneous fermentation” or “natural fermentation” or “fermentation process” as used herein is one that employs endogenous microorganisms naturally present in and/or unconsciously introduced into the organic material at the start or during the fermentation. By means of example and not limitation, in spontaneous fermentation of cocoa beans and pulp, microorganisms may be introduced after the beans and the pulp are released from the pods from natural microbiota present, for example, on workers' hands, tools (knifes, shovels, unwashed baskets, etc.), in the air where the pods are being broken open, the fermentation box or basket, coverings such as banana leaves, jute or other sacks and in places of previous fermentations. Accordingly, in the methods of the invention an otherwise spontaneous fermentation may be regulated by addition of a composition comprising one or more exogenous yeast strains to the organic material e.g., cocoa beans and pulp. Additionally, prior to the addition of exogenous yeast strains, endogenous yeast and bacteria naturally present in the organic material may be inhibited by the addition of microbial growth inhibitors such as sulfites. Thereby, the microbial presence in the materials is altered and the fermentation is thereby regulated (manipulated or modulated). The microbial strains introduced by means of the said compositions may be the same or similar (e.g., of the same species and/or genus) to those naturally found in the organic material and/or may be different (e.g., of a different species and/or genus).

By “Traditional” or “Conventional” fermentation is meant the fermentation process that occurs during the commercial production of cocoa, i.e., the large scale fermentation in a heap, box or basket. Traditional or conventional fermentation in the context of the present invention is also meant to include the fermentation of cocoa beans from pods from more than one cocoa tree. Traditional and conventional fermentation also includes fermentation of cocoa beans from pods from one or more trees by adding the beans to a pre-existing fermentation heap, box or basket. During a traditional or conventional fermentation, the order of microbial succession is led by yeasts that will dominate the total microbiome during the first hours after which their level is surpassed by lactic acid bacteria (LAB) which in turn will decline after 48 hours of fermentation in favor of the vigorous development of acetic acid bacteria (AAB). There are usually overlapping populations of yeast and LAB and then LAB with AAB.

The term “food product” is used herein in a broad sense, and covers food for humans as well as food for animals (i.e. a feed). In a preferred aspect, the food is for human consumption.

The term “about” or “approximately” as used herein when referring to a measurable value such as a parameter, an amount, a temporal duration, and the like, is meant to encompass variations of +/−20% or less, preferably +/−10% or less, more preferably +/−5% or less, and still more preferably +/−1% or less of and from the specified value, insofar such variations are appropriate to perform in the disclosed invention. It is to be understood that the value to which the modifier “about” or “approximately” refers is itself also specifically, and preferably, disclosed.

The term “significant” as used herein when referring to a measurable value such as a parameter, an amount, and the like. In some aspects significant is meant to encompass variations of +/−20%, preferably +/−10%, or +/−5% or less, insofar such variations are appropriate to perform in the disclosed invention.

The terms “one or more” or “at least one”, such as one or more or at least one member(s) of a group of members, is clear per se, by means of further exemplification, the term encompasses inter alia a reference to any one of said members, or to any two or more of said members, such as, e.g., any ≧3, ≧4, ≧5, ≧6 or ≧7 etc. of said members, and up to all said members.

The term “sensory characteristic” refers to an organoleptic sensation comprising one or all of the following characteristics: the sensations associated with recognized mouth taste sensations associated with in-mouth receptors (sweet, sour/acid, salty, bitter, umami, fatty); the sensations associated with the retronasal characterization of volatile elements of flavor (fruit, floral, etc.); and other mouth sensations not necessarily associated with specific receptors (astringency, creamy, gritty).

In a preferred embodiment, said “sensory characteristic” is a “taste characteristic”, which can be used interchangeably with “flavor characteristic”.

All these terms relate to gustation (i.e. tasting) of cocoa beans or derived products therefrom. In general, overall taste is composed of different taste characteristics. By means of example, and without limitation, in the context of cocoa or derived products therefrom, the following sensory characteristics, such as taste characteristics, can be discerned: astringent, bitter, sour, acidity, fruity, flowery, total intensity, aftertaste intensity, aftertaste time, cocoa taste, chocolate taste, aromatic, winey, putrid, carbon, and grilled, as well as off-note flavors including baggy, smoky, mouldy, earthy, raw, hammy, metallic, rancid, burnt and musty. These sensory characteristics are all well known in the art, and the most important ones are briefly described for further guidance.

“Astringent” can be defined as the chemical feeling factor perceived on the tongue and other oral surfaces, described as puckering or drying, elicited with tannins or alum. Astringency is associated with the action of polyphenols and peptide materials. Cocoa material which is astringent may be perceived as less desirable by certain consumer groups.

“Cocoa” can be defined as the basic cocoa note, which is characteristic of well fermented, de-shelled, roasted, and ground cocoa beans especially characteristic of specific types or genotypes (eg: Amelonado, Comum, or West African types).

“Bitter” can be defined as one of the four basic tastes perceived most sensitively at the back of the tongue, stimulated by solutions of caffeine, quinine, and other alkaloids.

“Acid” or “Sour” can be defined as one of the four basic tastes perceived on the tongue, associated with acids like citric acid.

“Total intensity” can be defined as a full-flavor intensity contrasting with watery. It indicates the “overall” or total flavor intensity of the product.

“Bouquet” is a general term covering all flavor elements over and above the cocoa character, e.g. aromatic, floral, and fruity notes.

The present method encompasses the processing of cocoa beans by harvesting cocoa beans from cocoa pods; placing the cocoa beans in a container and fermenting the cocoa beans at a controlled temperature for a predetermined period of time under substantially anaerobic conditions.

By substantially anaerobic condition it is meant that acetic acid bacteria do not grow and/or metabolize in an amount sufficient to produce significant acetic acid and/or oxidizes ethanol to acetic acid. The term “significant” is meant to encompass variations of 4 mg of acetic acid per g of fermented seeds or less, preferably 2 mg or less, more preferably 1 mg or less, and still more preferably 0 mg.

The container is capable of being sealed and in some embodiments has an airlock. Sealing the container prevents the introduction of oxygen in the container. The airlock allows the exhaust of carbon dioxide produced by the fermentation without the introduction of air into the container. Optionally, the container further contains a means for selectively introducing or removing fluid from the container. For example, the container contains a valve that allows the sweating to be drained without introduction of air. Preferably, the container is sterile. Optionally, the container includes a means to allow for mixing of the contents, either manually or in an automated fashion. In some embodiments, the container includes a means to regulate the temperature of the contents. The processed cocoa beans are then subjected to conventional drying, roasting and milling processes to produce cocoa products.

Optionally, the cocoa beans are inoculated with a cocoa starter culture. The term “starter culture” refers to a composition comprising live yeast(s) that are capable of initiating or effecting fermentation of organic material, optionally after being cultivated in a separate starter medium for obtaining a high density culture. A starter culture may be, e.g., a liquid culture, liquid pressed culture, frozen or dried form, including, e.g., freeze dried form and spray/fluid bed dried form, or frozen or freeze-dried concentrated. When a liquid culture is used the volume of the culture and concentration of yeast within the culture volume will be dependent on the volume of the fermentation mass. Sufficient volume and concentration of liquid culture needs to be added in an amount sufficient for efficient fermentation of the pulp and beans. For example, 400 mg of dry yeast per kg of fruit seeds. Preferably, the manufacturer's directions for yeast addition are followed as for wine. The culture may be packed in vacuum, or under an atmosphere of, e.g., N₂, CO₂ and the like. For example, a starter culture may be produced and distributed in sealed enclosures, which can be made of a rigid, non-flexible or flexible suitable plastic or other material, to the fermentation place and may be either added to organic material to be fermented, or optionally first cultivated in a separate starter medium (e.g., separate cocoa pulp) to obtain a high density culture. A starter culture may also contain, in addition to the yeast, buffering agents and growth stimulating nutrients (e.g., a digestible carbohydrate or a nitrogen source), enzymes (e.g. pectinase) or preservatives (e.g., cryoprotective compounds) or other carriers, if desired, such as milk powder or sugars.

A starter culture may be a pure culture, i.e., may contain a biomass of one single isolate (i.e. a clone originating in principle from one cell) of yeast. In other embodiments, a starter culture may be a co-culture, i.e., may comprise more than one strain of yeast. Suitable yeast starter cultures may include, but are not limited to Saccharomyces spp., S. cerevisiae.

The optional starter culture may be incubated for about 10, 15, 20, 30, 45 minutes prior to adding to the beans. In some embodiments the optional starter culture may be incubated for 1-48 hrs prior to adding to the beans. In other embodiments, the starter culture is incubated for about 1-30 hrs prior to adding to the beans. For example, the starter culture is incubated for about 3-16 hrs prior to adding to the beans. The incubation conditions (e.g., temperature) are preferably conducive to the growth or activation of the starter culture. Optimal incubation conditions are dependent upon the yeast strain used and are known to those skilled in the art

Once the beans and optional starter culture are placed in the container, all or a portion of the air is optionally removed from the container and the container is sealed. The skilled artisan can appreciate that while it may be desirable to remove the air from the container to insure anaerobic fermentation, this step may not be required as the byproduct of anaerobic fermentation is carbon dioxide, of which may be sufficient to produce a substantially anaerobic fermentation without the step of removing the air from the container. Removal of all or a portion of the air from the container may be achieved for example, by sparging with a non-oxidizing gas such as carbon dioxide, argon or nitrogen. One skilled in the art will appreciate that depending upon the yeast strain used oxygen may be required initially in the container for optimum initial growth of the yeast. One skilled in the art would further appreciate that once the yeast begin to grow that sufficient carbon dioxide will be produced to create a substantially anaerobic condition.

The cocoa beans are fermented under anaerobic conditions for a predetermined period of time, such predetermined period of anaerobic fermentation being about 12, 24, 36, 48, 60, 72, 96, 120, 144, 168 hours or more.

The fermentation process is carried out at a controlled temperature. Temperature control is optionally accomplished by a heat pump and a thermostat operatively coupled to the container, or the container may be water jacketed. Other well known means for controlling temperature, for example internal coils with optional gentle agitation, may also be used.

“Controlled temperature” means that the temperature is regulated. A controlled temperature may be one or more temperatures. In other words the controlled temperature may be a series of temperatures within the disclosed temperature ranges. All that is required is that the temperature is regulated. A controlled temperature is less than about 60° C., less than about 55° C., less than about 48° C. The controlled temperature is between about 28° C. to about 60° C. The controlled temperature is between about 28° C. to about 44° C.; above 28° C. to about 50° C.; above 28° C. to about 55° C.; about 37° C. to about 44° C.; about 37° C. to about 50° C. or about 37° C. to about 55° C. In some embodiments the controlled temperature is about 44° C. or about 37° C. The controlled temperature is between about 30° C. to about 60° C. The controlled temperature is between about 30° C. to about 44° C.; above 30° C. to about 50° C.; above 30° C. to about 55° C. The controlled temperature is for example, about 30° C., 33° C., 36° C., 39° C., 42° C., 45° C., 48° C., or 51° C.

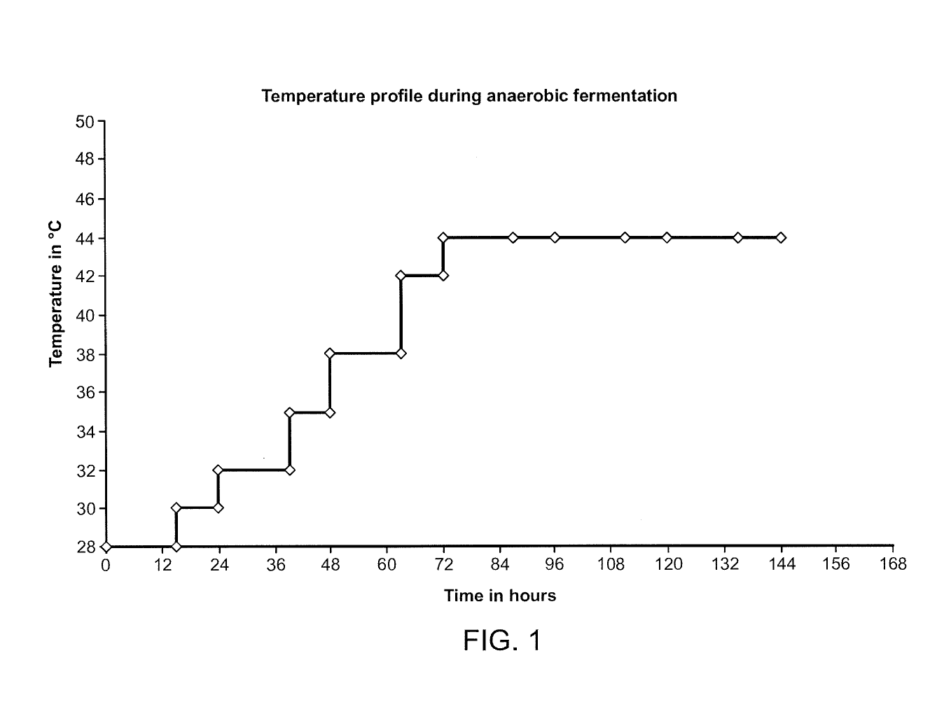

In one embodiment the temperature is controlled to mimic what happens in a traditional fermentation heap, box or basket. For example, during the anaerobic fermentation phase of a traditional fermentation, the temperature increases from about 25-30° C. to about 44-52° C. (usually 48-50° C.). Preferably, the temperature profile maintained during the process of the invention should be similar to the temperature profile as a traditional fermentation process. For example, the controlled temperature follows the temperature profile as shown in FIG. 1.

Once the desired maximum temperature is obtained, the temperature is held constant for a period of time.

The total period of time for incubation at 28° C. or above, is less than 2 weeks, a week, about 288 hours, less than one week, about 168 hours about 156 hours, about 144 hours, about 132 hours, about 120 hours, about 108 hours, about 96 hours, about 84 hours, about 72 hours, about 60 hours about 48 hours or less.

The period of time is when fermentation is complete or when the alcohol concentration of the fermenting mass reaches at least about 5% or more. In one embodiment, the period of time of at least 28° C. is 144 hours such as for example using the temperature profile as shown in FIG. 1 wherein each point on the graph represents the point at which the temperature of the airtight container was changed.

In some aspects the temperature is allowed to rise naturally for a first period of time (due the production of heat during fermentation) and then held at a desired temperature for a second period. Alternatively, the temperature is held at a first temperature for a first period of time and then held at a second temperature for a second period of time. Optionally the temperature is held for a third temperature for a third period of time, a forth temperature period of time, or a fifth temperature for a fifth period of time.

For example, the first temperature is between 28-40° C. and the second temperature is about 45° C. In another embodiment, the first temperature is between 30-40° C. and the second temperature is about 45° C. The first period of time is between 12 and 68 hours. The first period of time is longer than 48 hours. Alternatively, the first period of time is the period of time that is required for the ethanol concentration of the retained sweating to reach about 5%. Preferably, the first period of time is the period of time that is required for the ethanol concentration of the retained sweating to reach about 7%. The second period of time is between 24 and 96 hours. Preferably, the second period of time is at least 48 hours. More preferably, the second period of time is the period of time that is required for the concentration of ethanol within the bean to reach equilibrium with the concentration of ethanol of the retained sweatings.

Where a yeast starter culture is used, the first temperature may be a temperature or range of temperature which is the optimum temperature or temperature range for the yeast to grow and reproduce.

The temperature is controlled for a predetermined period of time. The period of time is also referred to herein as the fermentation period. The fermentation period may vary depending upon the seed cultivar being processed. The fermentation period is less than 2 weeks, a week, less than one week about 156 hours, about 144 hours, about 132 hours, about 120 hours, about 108 hours, about 96 hours, about 84 hours, about 72 hours, about 60 hours about 48 hours or less. In some embodiments, the fermentation period is the time that is required for cocoa bean death to occur. By cocoa bean death is meant that the germination of cocoa beans has been inhibited. The term “germination of cocoa beans (cocoa seeds)” as used herein refers to the sprouting of a cocoa seedling from a cocoa seed. “Inhibition” of germination as used in the present application is intended to refer to the effect of avoiding the start of germination of the cocoa but also to the effect of ending (interrupting) germination of the cocoa seeds if germination has already started. Germination of at least 80%, and preferably at least 85%, 90%, 95%, and even up to 100% of the cocoa beans is inhibited. Inhibition of germination can be measured by determining a germination rate by means of a germination assay. The germination rate is the number of cocoa seeds that germinate under proper conditions, and in particular, that germinate when growing the cocoa seeds on earth or cotton for 7 days at 25-31° C. under humidity saturated conditions. The germination rate is expressed as a percentage, e.g. a 15% germination rate indicates that about 15 out of 100 seeds germinate.

During the fermentation period, it may be desirable to mix, agitate, turn, or stir the beans in the container. This may be achieved manually or mechanically. In some embodiments the cocoa beans are mixed, agitated, turned, or stirred continuously or at regular intervals. For example, the cocoa beans are mixed, agitated, turned, or stirred at over about 24 hours, about 48 hours, about 72 hours, about 96 hours after the initiation of the fermentation period.

During fermentation, the process produces wet “sweatings”. During the period of fermentation, the sweatings may be drained from the container. For example, the sweatings may be drained from a valve. Alternatively, the sweatings are not drained until fermentation (e.g. anaerobic fermentation) is completed. One skilled in the art would recognize that if it was desired to stop fermentation prior to the completion of fermentation that draining of the sweating and drying the beans is one method in which this could be achieved. Alternatively, the same effect could be created by removing the beans from the sweatings rather than draining the sweating and then drying the beans.

In some embodiments the cocoa beans include the pulp or a portion thereof. Alternatively, the cocoa beans are substantially depulped from their original pulp in which case another suitable carbohydrate source will be required to sustain yeast growth. When including the pulp, the pulp may be separated from the cocoa beans. The pulp is derived from the same cultivar as the cocoa beans. Alternatively, the pulp is derived from a different cultivar than the cocoa beans. Optionally, the pulp may be mechanically processed prior to the addition to container. For example, the pulp may be mashed or blended.

To insure that none or minimal bacterial fermentation occurs during the method of the invention, the cocoa beans and pulp may be pre-treated prior to addition to the container to insure that endogenous bacterial activity is inhibited. For example, the cocoa beans and pulp may be treated with a sulfite solution or similar food grade antimicrobials.

In another embodiment, at least a part of the cocoa beans are dried or pre-dried before the actual process. This operation may be or may not be preceded by a reduction of pulp as described above. The pre-drying step may be carried out in any conventional hot air dryer, such as a circular drier, or using any alternative drying system such as sun drying. The cocoa beans are dried until the total moisture content is between 25-50%.

Various pre-treatments (mechanical and physical) and combinations thereof may be applied in accordance with the present invention.

Mechanical treatments include for example, depulping, scoring, scraping, chopping, cracking, crushing, pressing, bruising, rubbing, centrifugation, piercing, cutting or perforation of the cocoa beans and any combinations thereof.

Mechanical treatment facilitates the transport of fluids and gases from the interior of the seed across shell to the exterior environment. In particular, mechanical treatment allows for aeration of cocoa beans and of cocoa cotyledons.

As used herein, “pierce” generally refers to forming an opening in a cocoa bean, while leaving the portion of the cocoa bean surrounding the opening substantially intact. “Intact” generally refers to unitary or whole. A pierced cocoa bean may be a perforated cocoa bean. A “perforated” cocoa bean refers to a cocoa bean pierced in one, two or more locations to form openings. The openings may be substantially uniform in size and/or shape. Cocoa bean may be pierced in a variety of methods, such as piercing with a solid object, piercing with a fluid jet, piercing with droplets of enzymes or acids, piercing with electromagnetic radiation, or combinations thereof.

Physical treatments include for example, a thermal treatment (e.g. heating, chilling or freezing), a microwave treatment, a treatment under water-saturated conditions, an ultrasound treatment, an infra-red treatment, a laser treatment, a pressure treatment, a vacuum treatment and any combinations thereof.

In alternative embodiments, no pre-treatment to the cocoa beans are applied. In some embodiments the cocoa beans used in the method according to the invention are intact cocoa beans at the beginning of fermentation. Specifically, in some embodiments of the invention the cocoa beans are not pierced.

In some embodiments additive(s) are included during the fermentation. Additives include for example, acids such as citric acid, acetic acid, phosphoric acid; enzymes such pectinase; microbial growth inhibitors; preservatives; or an aromatic or tastant substance; growth promoters such as diammonium phosphate or other yeast nutrients.

Preferably, additive(s) is/are added to the cocoa beans at the beginning of the fermentation period or up to 24 hrs after the start of the fermentation period. In one embodiment, additives(s) is/are added to the cocoa beans up to 24 hrs, or up to 36 hrs, or up to 48 hrs, up to 72 hrs or up to 96 hrs after the start of the fermentation period.

Aromatic or tastant substances (e.g. salts, spices, aromatic wood and synthetic aromatic substances) may be any natural, natural identical or artificial aromatic substance or tastant substance used in the food industry and elsewhere. This includes substances that can be smelled and/or tasted. Generally, the aromatic substance or tastant are capable of modifying the flavor and/or aroma of the cocoa beans during the fermentation process.

Preferred solid or aqueous aromatic or tastant substances are fruit pulps, aromatic leaves, roots, flowers, stems, wooden parts, such as pieces of aromatic timber, any kind of powders (such as ground aromatic powders, herbs or spices.

Preferred liquid aromatic or tastant substances are oils such as essential oils and juices (e.g., fruit juices) made of a plant or made of fruit pulp.

In one embodiment, at least one aromatic or tastant substance as listed in the European “Register of flavoring substances notified by the Member States pursuant to Article 3(1) of Regulation ECNo 2232/96 of the European Parliament and of the Council of 28 Oct. 1996 laying down a Community procedure for flavoring substances used or intended for use in or on foodstuffs”, in the version published in the Official Journal of the European Communities, L 84, Volume 42, dated 27 Mar. 1999, is used. The content of said Register (in particular the names of the flavoring substances and the respective CAS numbers insofar these had been attributed or made available) is herewith incorporated by reference in its entirety.

In certain embodiments, the aromatic or tastant substance is a salt such as acetic or lactic salt.

In certain embodiments, the aromatic or tastant substance is a dutching agent such as sodium carbonate, sodium bicarbonate, ammonium hydroxide.

Other aromatic substances suitable for use in the present invention include for example those disclosed in W0 2009/103137, the contents of which are incorporated by reference in its entirety.

After the fermentation period, the cocoa beans are removed from the container and the cocoa beans are dried until the total moisture content is less that 10 percent, preferably the cocoa beans are dried to about 7 to 8 percent moisture. Once dried to the appropriate moisture content, the cocoa beans may be aged. Aging allows for the eliminating of some flavor artifacts. For example, the cocoa beans are aged for 2, 3, 4, 5, 6, 7, 8, 9, 10 or more weeks, preferably at least 6 weeks, at room temperature, prior to liquor making. Some genotypes may age faster, some may age a bit slower, but in general the 6 week aging is a good balance point between undue aging time and eliminating some flavor artifacts.

After the cocoa beans are dried and optionally aged, the beans are roasted and milled to liquor using procedures well known in the art, including roasting the beans; removing the shell and milling the recovered cocoa nibs into cocoa liquor. The cocoa liquor obtained from cocoa beans processed by the methods of the invention have sensory characteristics substantially the same as cocoa liquor produced by traditionally fermented cocoa beans. By sensory characteristics substantially the same as cocoa liquor produced by traditionally fermented cocoa beans, is meant that an individual trained in chocolate sensorial analysis and familiar with the flavor of beans from cocoa trees of various genotypes fermented via traditional fermentation processes will recognize that the sensory characteristics obtained by the method of the invention produces sensory characteristics of what experts would expect over a large number of commercial fermentations of beans from these genotypes.

According to the invention, sensory characteristics, such as taste characteristics of all cocoa-derived material, in addition to cocoa liquor can be evaluated. Accordingly, in an embodiment, sensory characteristics are scored for cocoa-derived material such as cocoa beans, cocoa powder, cocoa butter, cocoa nibs, cocoa pulp, cocoa flakes, cocoa extract, cocoa mass, cocoa cake, and chocolate. As cocoa liquor represents a homogenous cocoa derivative, sensory characteristics may advantageously and preferably be evaluated for cocoa liquor.

Sensory characteristics such as taste characteristics are usually evaluated by means of a taste panel. Taste panels can be consumer taste panels or expert or trained taste panels. Preferably, the taste panel is an expert or trained taste panel, in which all members thereof are familiar with the protocols and taste characteristics, which allow for a more objective evaluation of the taste characteristics. Taste panels are well known in the art. In essence, each member of the taste panel scores one or more taste characteristics, preferably on a numerical scale. Scores typically vary between a minimum score, corresponding to the (substantial) absence of the taste characteristic, and a maximum score, corresponding to a very strong or dominant presence of the taste characteristic. A number of intermediate scores between the minimum and maximum score are typically also presented. It is to be understood that references herein to a comparison of sensory or taste characteristics essentially relate to a comparison of the score of such sensory or taste characteristic. In some embodiments the scores of the cocoa products produced by the methods of the invention are substantially similar to the scores of the cocoa products produced by traditional fermentation. As used herein, the terms “substantially similar” preferentially refer to scores which differ by no more than 20%, preferably no more than 15%, more preferably no more than 10%, even more preferably no more than 5%.

The cocoa liquor obtained for cocoa beans processed by the method of the invention have sensory characteristics of cocoa liquor that are within the range of what an individual trained in chocolate sensorial analysis would expect from cocoa liquor produced by traditionally fermented cocoa beans.

In some embodiments the cocoa liquor obtained for cocoa beans processed by the method of the invention are superior to the sensory characteristics of cocoa liquor produced by traditionally fermented cocoa beans. By superior it is meant that an individual trained in chocolate sensorial analysis determined that the quality of the cocoa liquor obtained by the method of the invention is higher in at least one or more cocoa flavor attributes than the chocolate liquor obtained by traditional fermentation. Preferably, quality of the cocoa liquor obtained by the method of the invention is higher in two, three, four, five or more cocoa flavor attributes than the chocolate liquor obtained by traditional fermentation.

Each sample can be evaluated for, including but not limited to, one or more of the following flavor attributes: “cocoa flavor” (as found in Ghanaian beans), “acidity” (qualifies the basic taste generated by dilute aqueous solutions of most acids), “bitterness” (qualifies the basic taste generated by dilute solutions of various substances such as caffeine, perceived on the top of the tongue and at the back of the palate), “fruity” (taste note belonging to the bouquet and which evokes a fruit which has reached maturity: apple, banana, pear and the like), “flowery”, e.g., “total floral’ or “floral woody” (corresponds to an olfactory sensation evoking flowers in general: rose, jasmine, hyacinth, lilac and the like), “nutty, nut skins, and caramel notes” (the taste and odor of roasted nuts, nut skins, and caramelized sugars) “smoky” (taste and odor of smoke; defect resulting in general from drying the cocoa beans after fermentation by means of a wood fire), “hammy” (taste and odor of smoked ham or other smoked meat; defect resulting in general from diseased cocoa beans, “musty” (taste and odor of damp slightly moldy materials), and “raw” (feature of insufficiently roasted cocoas where the flavor has not developed); “earthy” (corresponds to an olfactory sensation that evokes fresh clean slightly damp earth or potting soil or the rich smell of the earth in a forest after a light rain). “bark woody”, “dirty”, etc. In addition, each sample can be evaluated for other sensations, including but not limited to, “astringency” (corresponds to sensations of a physical nature, from the suppression of unctuousness to the astringency in the medical sense which covers constriction and/or crispation of the tissues) or “other” (a compilation of flavors otherwise specified in the aforelisted attributes). “Other off” flavors as used herein refer to flavors such as cardboardy, stale, baggy, tar-like, burnt rubber, etc., flavors that would be considered to be “off flavors” that are known to a skilled person in the art and have not been aforementioned.

In addition to the sensory characteristics, the cocoa beans processed according to the methods of the invention, or the cocoa products produced therefrom, also have nutritional and chemical characteristics that are substantially similar or superior to cocoa beans that have been traditionally fermented. Nutritional and chemical characteristics include for example, fat, moisture, crude protein, theobromine, caffeine, sugars, starch, total dietary fiber, organic acids, ash, cholesterol, minerals (such as, without limitation, potassium, sodium, calcium, magnesium, phosphorus, chloride, iron, zinc, copper) or vitamins (such as, without limitation, A (retinol), B1 (thiamine), B2 (riboflavin), B3 (niacin), Vitamin B5, C (ascorbic acid), E (tocopherol)). The chemical composition equally relates to for instance fatty acid composition (such as percentages of saturated, monounsaturated or polyunsaturated fatty acids) and type (such as percentages of for instance palmitic (C16:0), stearic (C18:0), oleic (C18:1), palmitoleic (C16:1), linoleic (C18:2), arachidic (C20:0) or other fatty acids). Methods for determining these parameters are well known in the art (see for instance “de Zaan Cocoa & Chocolate Manual”, 2009, ADM Cocoa International, Switzerland).

In yet another aspect, the invention relates to cocoa beans that are obtained or obtainable by a carrying out a method according to the invention. Specifically, the invention also relates to cocoa products prepared with one or more cocoa beans as defined herein. “Cocoa products” according to the present invention are defined as products that can be prepared using cocoa beans, and such as cocoa powder, cocoa extract, cocoa liquor, cocoa mass, cocoa cake, and cocoa butter. Cocoa products can be in a liquid form or in a dry or lyophilized form, such as in the form of granules, pellets, or a powder.

The invention thus relates to the use of cocoa beans according to the invention for the preparation of food products, e.g. preferably chocolate products, and to food products thereby obtained. For this, cocoa beans according to the invention can be conventionally processed into cocoa products such as cocoa butter, cocoa powder, cocoa liquor, cocoa mass, and further introduced in food products.

The food may be in the form of a liquid or as a solid. Non limitative examples of food products which may be obtained using cocoa beans according to the present invention include for instance chocolate products, chocolate drinks, nutritional beverages, beverage powders, milk-based products, ice cream, confectionery, bakery products such as cakes and cake mixes, fillings, cake glaze, chocolate bakery filling, doughnuts, chocolate syrup, chocolate sauce, and dairy products.

Food products, e.g. chocolate products, comprising cocoa beans or cocoa products derived thereof as defined herein may have improved characteristics, including for instance improved storage stability, improved organoleptic properties such as for instance a better flavor profile, better flavor release, prolonged flavor retention and improved appearance, than equivalent products made from cocoa beans that have been traditionally fermented.

### EXAMPLES

### Example: 1

### Flavor Comparison of Anaerobically-Fermented Cocoa Beans to Traditionally-Fermented Cocoa Beans

Beans were obtained and fermented according to the methods of the invention and traditional fermentation. Specifically, six separate conditions were evaluated, which included:

TABLE 1

| | Sample | Con- | Starter | | |
|---|---|---|---|---|---|
| Exp | size | tainer | Culture | Temp | Time |
| 1 | 5 kg | Bag | Yeast only | FIG. 1Profile | 6 days |
| | | | | with final | |
| | | | | upper temp at 44 C. | |
| 2 | 5 kg | Bag | Yeast and | FIG. 1Profile | 6 days |
| | | | bacteria | with final | |
| | | | mix | upper temp at 44 C. | |
| 3 | 5 kg | Bag | Yeast only | Hold at 37 C. | 6 days |
| 4 | 5 kg | Bag | Yeast only | Hold at 25 C. | 6 days |
| 5 | 120 kg | Wood | none - | Natural heap profile | 5 days |
| | | box | natural | | |
| | | | fermentation | | |
| 6 | 120 kg | Wood | none -natural | Natural heap profile | 5 days |
| | | box | fermentation | | |

Mature, ripe, sound (non-diseased) cocoa pods were obtained from a cocoa planting in the vicinity of Itajuipe, Bahia, Brazil. The trees were primarily local genotypes typical of the area (PS 1319, CCN 51, Comum, and minor amounts of other genotypes). The collected pods were opened by machete the day following collection. During opening, any diseased or germinated beans were discarded.

For the fermentation boxes, Experiments 5 and 6, previously used 120 kg (wet bean basis) boxes were used. For the bag fermentations, Experiments 1, 2, 3, and 4, large ziplock type vacuum bags such as typically used for vacuum sealed storage of clothing or bedding were used (VacBag by Ordene, 55 cm×90 cm).

Following pod opening, the two previously used fermentation boxes were filled with the beans and their associated pulp. They were covered by banana leaves and a top layer of previously used (for fermentation) jute bags.

For the tests according to the method of the invention, Experiments 1, 3, and 4, a yeast starter (Lallemand Lalvin EC-1118, Saccharomyces cerevisiae bayanus) was used. The yeast was activated according to label directions by hydrating the yeast in 5 times its weight of potable water at 40° C. and standing for 20 minutes with gentle occasional stirring to break up any lumps. This hydrated yeast was used at the manufacturer's labeled rate of 2 gm of yeast hydrated in 20 ml water for each 5 kg of beans with pulp. Beans with their associated pulp were placed in a large cleaned container, the yeast starter added, and gently mixed prior to loading into the vacuum bags.

For experiment Nos. 1, 3, and 4, a starter culture containing only yeast (i.e. anaerobic fermentation only) was used. In contrast, for experiment 2, a starter culture containing yeast, acetic acid bacteria and lactic acid bacteria (i.e., to re-create typical anaerobic and aerobic fermentation) was used. For experiments 5 and 6, traditional wood box fermentations were carried out with no starter cultures and any microorganisms present were therefore adventitious from the environment during pod opening as is the typical practice. Experiments 5 and 6 would therefore be expected to follow a typical anaerobic and aerobic fermentation progression.

For Experiments 1, 2, 3, and 4, following loading into the vacuum bags, the ziplock feature on the bags was sealed and a shop vac type of vacuum cleaner was used against the bag's vacuum valve to remove air from the bag. Sealed, air evacuated bags were placed into commercial temperature controlled incubators. Temperature for the incubator followed the conditions specified in Table 1. Bags were not opened during the 6 days of fermentation but did fill with carbon dioxide generated by the metabolism of the yeast. Following the 6 days of fermentation, bags were opened, sweating drained and discarded, and the beans placed on sun drying tables, barcaça, typical of the region in Bahia, Brazil. Beans were exposed to the sun for drying and turned several times a day to promote even drying. Bean moisture was checked and the drying discontinued when beans reached a final moisture content of less than 7.5%. Following drying, beans were stored in clean, new, neutral odor jute bags in an ambient storage shed used for cocoa bean storage.

After fermentation, drying and storage the cocoa beans were roasted at 121° C. for 21 minutes in a convection oven. The roasted cocoa beans were used to produce cocoa liquor in a mortar grinder.

Flavor analysis was performed by a professional flavor taster on samples of the cocoa liquor. Specifically, cocoa, total acidity, bitterness, astringency, and total other off flavor attributes of the cocoa beans were assessed.

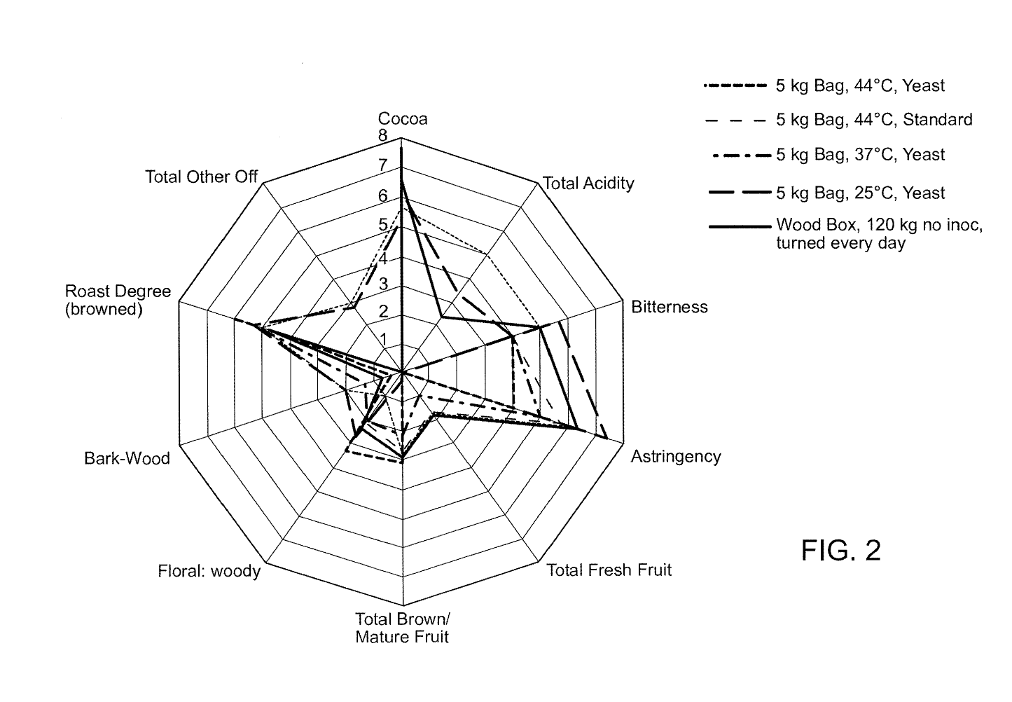

As shown in Table 2 below and FIG. 2, experiment 1 (FIG. 1 temperature profile, yeast starter culture, anaerobic conditions) resulted in cocoa beans with better cocoa flavor, lower total acidity and lower astringency, and fewer off-flavors compared to cocoa beans subjected to the traditional anaerobic and aerobic wooden box fermentation (experiments 5, and 6). Experiment 3 demonstrates that favorable characteristics can also be obtained when a yeast starter culture is used and the cocoa beans are held at a controlled temperature (rather than following a profile temperature curve as demonstrated by experiment 1). Experiment 2 also demonstrates that favorable results can be obtained when the starter culture contains bacteria as well as yeast. Experiment 4 demonstrates that lowering the temperature to below 28° C. results in a substantial increase in astringency and off flavors. Finally, experiments 5 and 6 demonstrate that the variability of results in a wooden box fermentation, something that the present invention seeks to overcome.

TABLE 2

| | | 5 kg Bag, FIG. 1 | | | | |
|---|---|---|---|---|---|---|
| | 5 kg Bag, FIG. 1 | profile with upper | | | | |
| | profile with upper | temp. at 44° C., | 5 kg Bag, | 5 kg Bag, | Wood Box, | Wood Box, |
| | temp. at 44° C., | yeast and | at 37° C., | at 25° C., | 120 kg, no inoc, | 120 kg, no inoc, |
| | Yeast | bacteria mix | Yeast | Yeast | turned every day | turned every day |
| | Exp 1 | Exp 2 | Exp 3 | Exp 4 | Exp 5 | Exp 6 |
| Cocoa | 7.7 | 6.3 | 6.3 | 5.3 | 6.7 | 5.7 |
| Total Acidity | 0.0 | 3.3 | 3.3 | 0.0 | 2.3 | 5.0 |
| Bitterness | 4.0 | 4.0 | 4.0 | 5.7 | 5.0 | 5.0 |
| Astringency | 4.0 | 5.7 | 5.0 | 7.3 | 6.3 | 6.3 |
| Total Other Off | 0.0 | 0.0 | 0.0 | 2.8 | 0.0 | 3.0 |

### Example 2

### Determination of the Optimal Temperature for the Development of Cocoa Flavor

To further evaluate the effect of temperature on the development of flavor, cocoa beans from multiple clones (e.g., PS1319, TSH 1188 and CCN 51) will be fermented according to the methods of the invention and traditional fermentation and multiple temperatures such as for example 30° C., 33° C., 36° C., 39° C., 42° C., 45° C., 48° C., and 51° C. Yeast cultures are prepared as described in Example 1.

Approximately 5 kg of cocoa beans are used per treatment.

Samples are collected at the same time such as 5 or 6 days and the beans are processed into cocoa liquor and assessed for flavor. The flavor profile of the chocolate liquor produced will be determined by a professional taster in a double blind taste test.

1. A method of fermenting seeds of fruit comprising:
a. placing a bulk quantity of the seeds in an airtight container;
b. sealing the container; and
c. fermenting the seeds at a controlled temperature of at least 28° C. for a predetermined period of time of less than two weeks under anaerobic conditions;
wherein the method does not comprise an aerobic fermentation step.

2. The method of claim 1, wherein said container comprises an airlock.

3. The method of claim 1, wherein the seeds are cocoa beans, cupuacu beans or coffee beans.

4. (canceled)

5. (canceled)

6. The method of claim 1 wherein the controlled temperature is between about 28-50° C.

7. (canceled)

8. The method of claim 1, wherein the predetermined period of time is between 24 to 168 hours.

9. (canceled)

10. The method of claim 1, wherein after about 72 hours the temperature is maintained at about 44° C. for at least an additional 48 hours.

11. The method of claim 1, wherein the controlled temperature is increased at defined intervals until a temperature of about 44° C. or 48 C is obtained, and further comprising maintaining the temperature at 44° C. or 48° C. for at least an additional 48 hours.

12. (canceled)

13. (canceled)

14. (canceled)

15. (canceled)

16. The method of claim 1, wherein the method further comprises inoculating the seeds with a starter culture comprising yeast prior to step (b).

17. The method of claim 1, further comprising treating the seeds with a microbial growth inhibitor prior to inoculating with the starter culture

18. (canceled)

19. (canceled)

20. The method of claim 1, wherein at least a portion of any air in the airtight container is displaced with a non-oxidizing gas comprising carbon dioxide, argon or nitrogen prior to step (b).

21. (canceled)

22. (canceled)

23. The method of claim 1, wherein the method further comprises separating the sweatings from the seeds at one or more a times during step (c).

24. The method of claim 1, wherein the seeds have been mechanically or physically processed prior to step (a).

25-27. (canceled)

28. The method of claim 3, wherein the method further comprises the step of:
drying the fermented seeds until the total moisture content is about 5 to 10 percent to produce dried seeds.

29. The method of claim 28, wherein the method further comprising the step of: roasting the dried seeds to produce roasted seeds.

30. (canceled)

31. (canceled)

32. The cocoa beans, cupuacu beans or coffee beans produced according to the method of claim 3.

33-38. (canceled)

39. The method of claim 1 wherein the controlled temperature follows the temperature profile as illustrated in FIG. 1.

40-45. (canceled)

46. A method of fermenting seeds of fruit comprising fermenting the seeds for a predetermined period of time under anaerobic conditions; wherein the method does not comprise an aerobic fermentation step.

47. A method for the manufacture of food products comprising:
a. placing a bulk quantity of fruit seeds in an airtight container;
b. sealing the container;
c. fermenting the seeds at a controlled temperature of at least 28° C. for a predetermined period of time of less than two weeks under anaerobic conditions;
d. processing the fermented fruit seeds to provide a food product;
wherein the method does not comprise an aerobic fermentation step.

48. The method of claim 46, wherein the fruit seeds are cocoa or cupuacu pods or coffee beans and the food product comprises a cocoa, cupuacu or coffee product.

49. A food product prepared by the method of claim 46.
